(19) United States
(12) Patent Application Publication
(10) Pub. No.: US 2019/0092397 A1
(43) Pub. Date: Mar. 28, 2019

(54) HOLE PLUG

(71) Applicant: PIOLAX, INC., Yokohama-shi (JP)

(72) Inventor: Naoki SUGIMOTO, Yokohama-shi (JP)

(21) Appl. No.: 16/139,562

(22) Filed: Sep. 24, 2018

(30) Foreign Application Priority Data
Sep. 25, 2017 (JP) 2017-183185

(51) Int. Cl. B62D 25/24; F16B 37/14; F16J 15/02; F16J 13/14

(52) U.S. Cl. CPC B62D 25/24; F16J 13/14; F16J 15/025; F16B 37/14

(57) ABSTRACT

There is provided a hole plug. The hole plug has a main body portion and a seal flange portion. The main body portion has a closing portion, an inner wall portion, an outer wall portion. The seal flange portion extends outwards from the outer wall portion and has an abutment portion. A first recess portion is provided on an outer surface of the seal flange portion, a thin portion whose minimum thickness is thinner than a thickness of a portion of the outer wall portion which is located closer to the other end side thereof than the engaging portion is formed on the first recess portion. The thin portion is disposed closer to a radially inner side of the seal flange portion than a position on the abutment portion which is located nearest to the outer wall portion.

### CROSS-REFERENCE TO RELATED APPLICATIONS

The disclosure of Japanese Patent Application No. 2017-183185 filed on Sep. 25, 2017, including specification, drawings and claims is incorporated herein by reference in its entirety.

### TECHNICAL FIELD

The present disclosure relates to a hole plug for closing a hole provided in a predetermined member.

### BACKGROUND

There are cases where a hole is formed in, for example, a body panel or a lid of a motor vehicle for a specific application. In the event that the hole so formed is left as it is, there is caused a problem with a sealing performance or an external appearance, and therefore, to solve the problem, it is general practice that the hole is closed with a hole plug.

Patent Document 1 below describes, as a related-art hole plug of this type, a hole plug including a main body portion configured to close a hole and having an inserting portion to be inserted into the hole and a seal flange portion extending into a skirt from an outer circumference of the main body portion to be brought into abutment with a front circumferential edge of the hole, wherein an outer annular projecting portion and an inner annular projecting portion, which constitute a double annular configuration, are formed on a rear surface side of a distal end of the seal flange portion in its extending direction. The inserting portion is made up of a closing portion, an inner circumferential wall hanging from a circumferential edge of the closing portion, and an outer circumferential wall which is folded back from a distal end of the inner circumferential wall to rise on an outer side of the inner circumferential wall in a concentric fashion. The seal flange portion extends from an outer circumference of a distal end of the outer circumferential wall. The outer circumferential wall is designed to be disposed on an inner side of the hole, and an engaging portion, which is configured to be brought into engagement with a rear circumferential edge of the hole, is provided on an outer side of the outer circumferential wall.

Patent Document 1: Japanese Patent Publication No. 5449556 B

With the hole plug of Patent Document 1 described above, when the hole plug is inserted into a hole, the seal flange portion is brought into abutment with the predetermined member to be deformed, whereby the outer circumferential wall flexes towards the inner side of the hole as the seal flange portion is deformed. Due to this, a gap is generated between the outer circumferential wall and the hole, resulting in fears that the sealing performance of the hole plug relative to the hole is reduced.

### SUMMARY

It is at least one of objects of the present disclosure to provide a hole plug which can suppress a deformation of an outer wall portion caused as a seal flange portion is deformed to thereby enhance a sealing performance of the hole plug.

According to an aspect of the embodiments of the present disclosure, there is provided a hole plug for closing a hole provided in a predetermined member, having a main body portion configured to be inserted into the hole and a seal flange portion configured to be brought into abutment with a front circumferential edge of the hole, wherein the main body portion has a closing portion disposed on a front side of the hole, an inner wall portion extending from the closing portion to be inserted into the hole, an outer wall portion disposed on a radially outer side of the inner wall portion so as to be spaced apart therefrom and extending from one end side towards the other end side of the inner wall portion in its extending direction to be inserted into the hole and an engaging portion provided on an outer circumference of the outer wall portion to be brought into engagement with a rear circumferential edge of the hole, wherein the seal flange portion extends outwards from the other end side of the outer wall portion and has an abutment portion configured to be brought into abutment with the front circumferential edge of the hole, and wherein a first recess portion having a recess configuration extending continuously along a full circumference of the seal flange portion is provided on an outer surface of the seal flange portion, a thin portion whose minimum thickness is thinner than a thickness of a portion of the outer wall portion which is located closer to the other end side thereof than the engaging portion is formed on the first recess portion, and the thin portion is disposed closer to a radially inner side of the seal flange portion than a position on the abutment portion which is located nearest to the outer wall portion.

According to the present disclosure, the first recess portion having the recess configuration extending continuously along the full circumference of the seal flange portion on the outer surface of the seal flange portion. The thin portion whose minimum thickness is thinner than the thickness of the portion of the outer wall portion which is located closer to the other end side thereof than the engaging portion is formed on the first recess portion. The thin portion is disposed closer to the radially inner side of the seal flange portion than the position on the abutment portion which is located nearest to the outer wall portion. Thus, when the main body portion is inserted into the hole to mount the hole plug in the hole whereby the abutment portion of the seal flange portion is brought into abutment with the front circumferential edge of the hole, the seal flange portion is deformed via the thin portion. This can facilitate a flexure of the seal flange portion, as a result of which the outer wall portion can be prevented from flexing towards the inner side of the hole to restrict a gap between the outer circumference of the outer wall portion and the inner circumference of the hole from expanding. This can enhance the adhesion between the outer wall portion and the hole to thereby improve the sealing performance of the hole plug.

### BRIEF DESCRIPTION OF THE DRAWINGS

In the accompanying drawings:

FIG. 1 is a perspective view showing an embodiment of a hole plug according to the present disclosure;

FIG. 2A is an enlarged perspective view of the hole plug, and FIG. 2B is an enlarged perspective view of the hole plug as seen from a different direction from the direction in which the hole plug is seen in FIG. 2A;

FIG. 3A is a plan view of the hole plug, and FIG. 3B is a bottom view of the hole plug;

FIG. 4 is a sectional view of the hole plug;

FIG. 5A is a sectional view showing a state in which the hole plug is mounted in a hole, and FIG. 5B is a sectional view showing a state in which the hole plug is mounted in a hole in a predetermined member whose thickness is thicker than a predetermined member shown in FIG. 5A; and

FIG. 6 is a sectional view showing a state in which the hole plug is pushed in further from the state shown in FIG. 5A.

### DETAILED DESCRIPTION OF THE EMBODIMENTS

Hereinafter, referring to the drawings, an embodiment of a hole plug according to the present disclosure will be described.

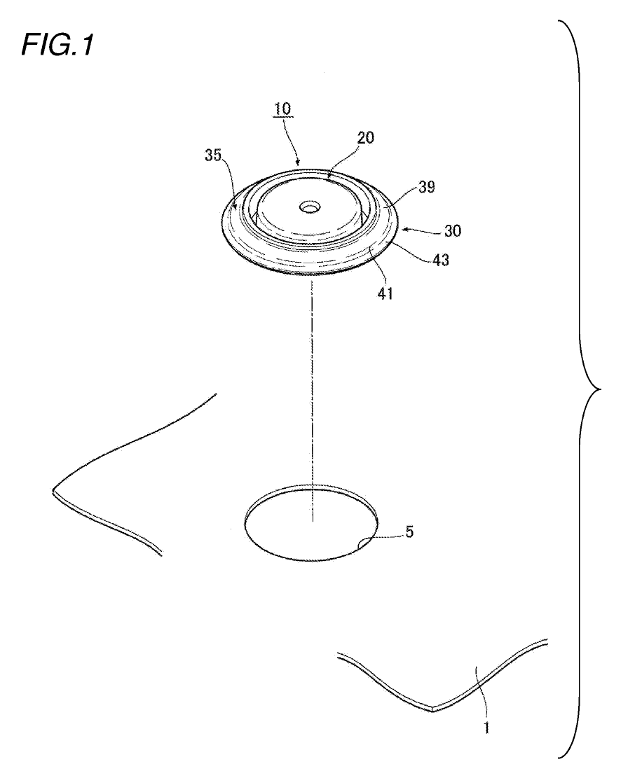

As shown in FIG. 1, a hole plug 10 of this embodiment is used to close a hole 5 provided in, for example, a predetermined member 1 such as a body panel or the like of a motor vehicle. In the case of this embodiment, the hole 5 has a circular disc shape but may have an elongated hole shape such as an oval or elliptic shape. The predetermined member 1 may be a lid of a luggage compartment, a trunk lid, a door, a fender or the like of a motor vehicle, and hence, there is imposed no limitation on the application thereof.

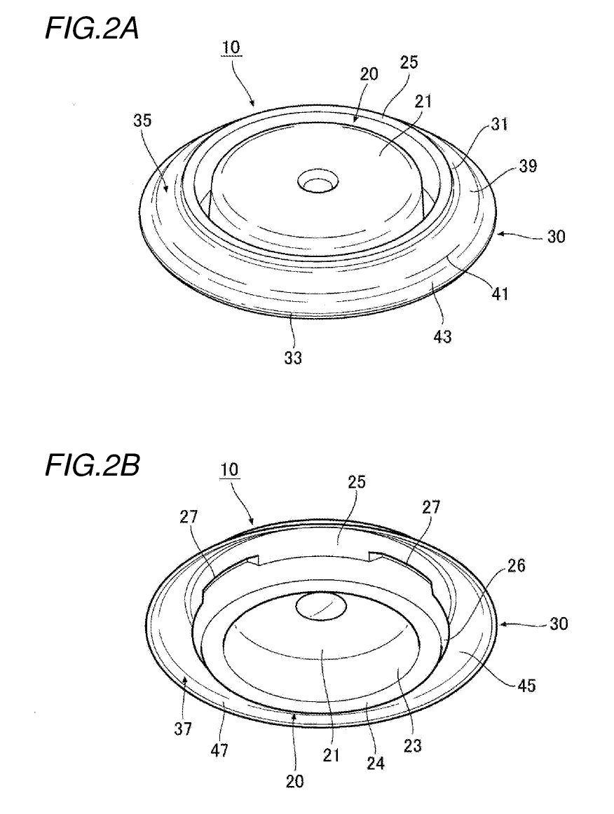

Then, as shown in FIGS. 2A to 4, the hole plug 10 (hereinafter, also referred to simply as the “plug 10”) of this embodiment has a main body portion 20 designed to be inserted into the hole 5 and a seal flange portion 30 designed to be brought into abutment with a front circumferential edge of the hole.

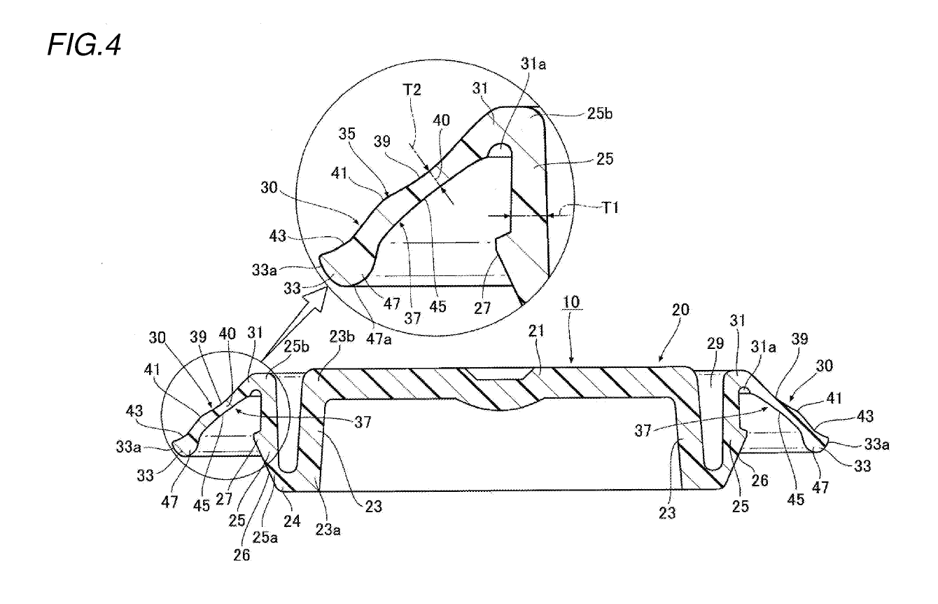

As shown in FIGS. 2A, 2B and 4, the main body portion 20 has a closing portion 21 disposed on a front side of the hole 5, an inner wall portion 23 extending from the closing portion 21 to be inserted into the hole 5, an outer wall portion 25 disposed on a radially outer side of the inner wall portion 23 so as to be space apart therefrom and extending from one end 23a side to the other end 23b side of the inner wall portion 23 in its extending direction to be inserted into the hole 5, and an engaging portion 27 provided on an outer circumference of the outer wall portion 25 to be brought into engagement with a rear circumferential edge of the hole 5.

The closing portion 21 of this embodiment has a circular disc shape, and the inner wall portion 23, having a cylindrical shape, extends from a circumferential edge portion of the closing portion 21 (refer to FIGS. 2B and 4). A folded-back portion 24 extends radially outwards from one end 23a of the inner wall portion 23 in its extending direction (the one end 23a means an end portion at a distal end side in the extending direction of the inner wall portion 23). The cylindrical outer wall portion 25 is disposed on the radially outer side of the inner wall portion 23 so as to be spaced apart therefrom via the folded-back portion 24 in a concentric fashion and extends towards the other end 23b side of the inner wall portion 23 (the other end 23b side means an end portion side located opposite to the one end 23a side in relation to the extending direction). An annular groove portion 29, which is opened on a closing portion 21 side thereof, is formed between the inner wall portion 23 and the outer wall portion 25, enabling the outer wall portion 25 to be deformed to be flexed.

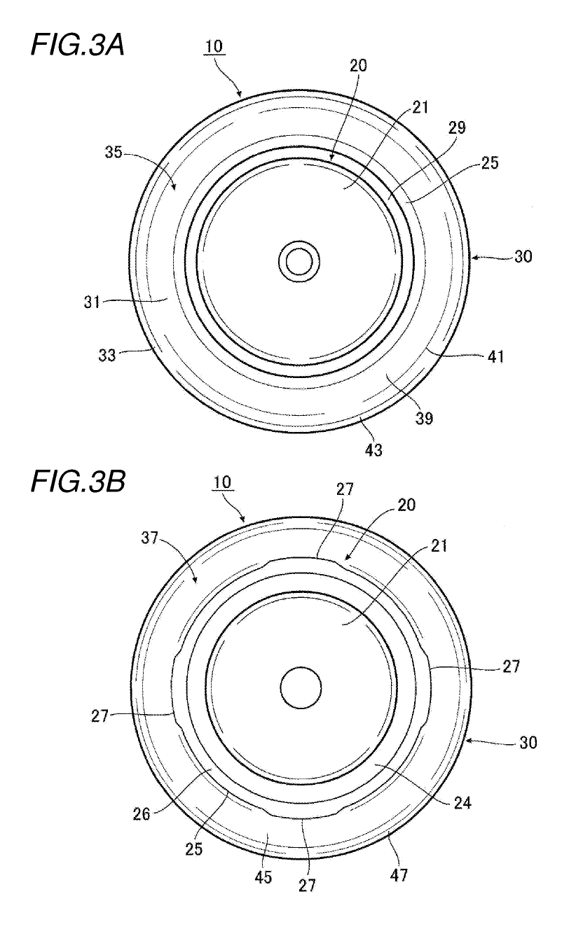

As shown in FIG. 4, an outer surface of one end 25a side of the outer wall portion 25 (the one end 25a side means an end portion side that is disposed on the same end portion side as the one end 23a of the inner wall portion 23 that is the distal end side end portion in the extending direction) constitutes a tapered surface 26 that gradually narrows in diameter towards the folded-back portion 24. Further, as shown in FIGS. 2B and 3B, the engaging portion 27 includes a plurality of engaging portions that are provided at regular intervals in a circumferential direction at an apex portion of the tapered surface 26 of the outer wall portion 25. In this embodiment, although four engaging portions 27 are provided, the number of engaging portions 27 is not limited to any specific number. Additionally, the engaging portion 27 may have an annular or arc-like shape.

The seal flange portion 30 extends outwards from the other end 25b side of the outer wall portion 25 of the main body portion 20 (the other end 25b side means an end portion side that is disposed on the same end portion side as the other end 23b of the inner wall portion 23 that is the end portion at the opposite side to the one end side 23a in relation to the extending direction of the inner wall portion 23). In this embodiment, the seal flange portion 30 (hereinafter, also referred to simply as the “flange portion 30”) extends from the other end 25b side of the outer wall portion 25 towards an opposite side to the closing portion 21 as expanding obliquely outwards into a skirt-like configuration. This flange portion 30 has an abutment portion 47 configured to be brought into abutment with the front circumferential edge of the hole 5 on an inner surface 37 side thereof. Specifically speaking, a proximal end 31 of the flange portion 30 in its extending direction is coupled to the other end 25b side of the outer wall portion 25, and the abutment portion 47 is provided at a distal end 33 side of the flange portion 30 in its extending direction on the inner surface 37 side so as to be brought into abutment with the outer circumferential surface of the hole 5.

Then, as shown in FIGS. 4 to 6, a first recess portion 39, a projecting portion 41, and a second recess portion 43 are provided sequentially in that order from a proximal end 31 side of the flange portion 30 on an outer surface 35 of the flange portion 30. On the other hand, a third recess portion 45 is provided on an inner surface 37 of the flange portion 30, and the thick abutment portion 47 is provided at a distal end 33 side on the inner surface 37 so as to protrude to have an arc-like cross section. Hereinafter, the individual constituent elements will be described in detail. In the following description, the outer surface 35 of the flange portion 30 means a surface on a side located farther away from the front side of the hole 5, and the inner surface 37 of the flange portion 30 means a surface on a side located nearer to the front side of the hole 5. Additionally, in the following description, the term “outer circumference” in the groove portion, the outer wall portion, the first recess portion, the projecting portion, and the third recess portion means a radically outer side of the steal flange portion, and an “inner circumference” means a radially inner side of the seal flange portion.

As shown in FIG. 3A, the first recess portion 39 is provided at an outer circumference of the groove portion 29 concentrically therewith on the outer surface 35 of the flange portion 30 and extends continuously in a circumferential direction along a full circumference of the flange portion 30. Additionally, as shown in FIG. 4, the first recess portion 39 has a depressed or inwardly curved cross-sectional shape having a curved surface that is curved inwardly into a bow-like shape from the outer surface 35 side of the flange portion 30 in a direction in which the flange portion 30 moves towards the front side of the hole 5.

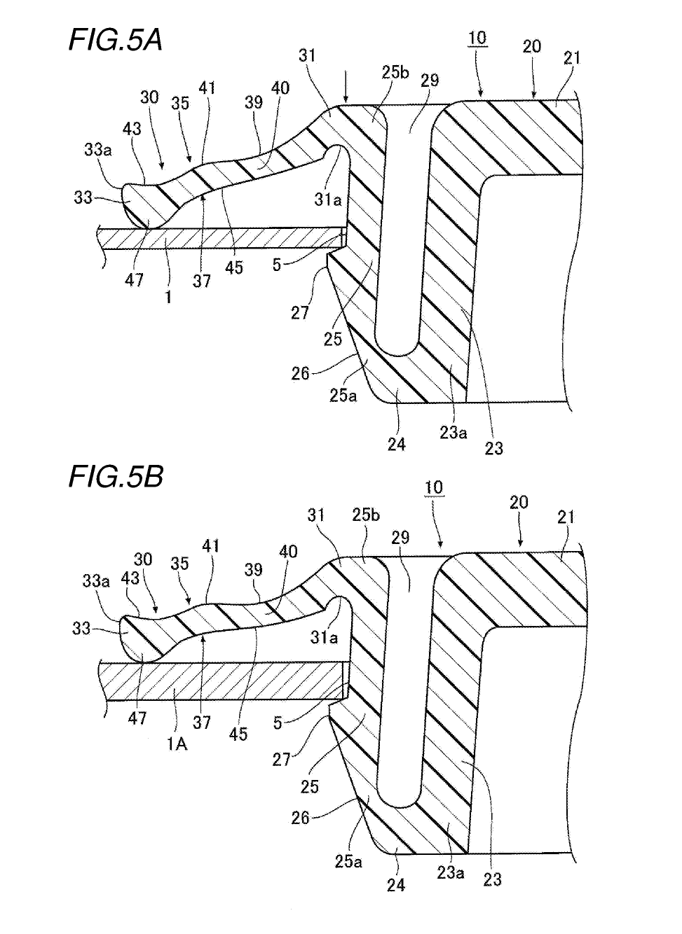

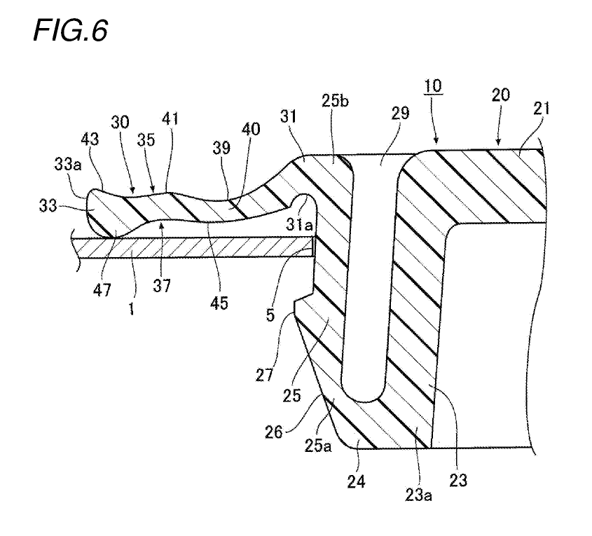

Further, as shown in FIG. 4, a thin portion 40 is formed at a portion of the first recess portion 39 that is recessed or inwardly curved deepest, that is, a portion that is curved so inwardly as to be nearest to the front side of the hole 5. A thickness T2 of the thin portion 40 is thinner than a thickness T1 of a portion of the outer wall portion 25 that is located nearer to the other end 25 side (meaning the end portion side that is disposed on the same end portion side as the other end 23b of the inner wall portion 23 that is the end portion located opposite to the one end 23a in relation to the extending direction of the inner wall portion 23) than the engaging portion 27 and constitutes a minimum thickness portion of the flange portion 30 (refer to FIG. 4). Namely, the minimum thickness T2 of the thin portion 40 is thinner than the thickness T1 of the portion of the outer wall portion 25 that is located nearer to the other end 25b side of the outer wall portion than the engaging portion 27 of the outer wall portion 25. Additionally, as shown in FIG. 4, this thin portion 40 is disposed further radially inwards of the flange portion 30 than a position on the abutment portion 47 of the flange portion 30 which is located nearest to the outer wall portion 25. Then, as shown in FIGS. 5A, 5B and 6, in mounting the plug 10 in the hole 5, when the main body portion 20 is inserted into the hole 5, bringing the abutment portion 47 of the flange portion 30 into abutment with the front circumferential edge of the hole 5, the flange portion 30 deforms via the thin portion 40 disposed further radially inwards of the flange portion 30 than the abutment portion 47. Namely, the flange portion 30 flexes and deforms via the thin portion 40.

As shown in FIG. 4, the first recess portion 39 is provided further radially inwards of the flange portion 30 than a position on the abutment portion 47 that is located nearest to the outer wall portion 25 on the outer surface 35 of the flange portion 30. To describe the location of the first recess portion 39 from a different point of view, the first recess portion 39 is provided somewhere from a position on the abutment portion 47 that corresponds to the position located nearest to the outer wall portion 25 to the proximal end 31 (here, somewhere from the projecting portion 41 to the proximal end 31 on the outer surface 35). Specifically speaking, in this embodiment, the first recess portion 39 is formed so that an inner circumference on a radially outer side of the flange portion 30 is positioned at an inner side (a radially inner side of the flange portion 30) of the projecting portion 41 and an inner circumference on a radially inner side of the flange portion 30 reaches the proximal end 31 of the flange portion 30.

A sectional shape of the first recess portion may be any of, for example, a shape that is depressed or inwardly curved substantially into the shape of an arc, a shape that is depressed or inwardly curved substantially into the shape of a valley and a shape that is depressed or inwardly curved substantially into the shape of a trapezoid having a bottom surface and slopes provided on both sides of the bottom surface so as to gradually expand or move away from each other. However, it is preferable that the first recess portion takes a shape that is depressed or inwardly curved with no angular portion to avoid a concentration of stress. In the case where the first recess portion is depressed or inwardly curved substantially into the shape of a trapezoid as described above, a thickness of a bottom portion of a predetermined length constitutes the minimum thickness T2, and therefore, it follows that the “thin portion” of the present disclosure is provided over the predetermined length.

As shown in FIGS. 3A and 4, the projecting portion 41 is provided so as not only to be disposed at an outer circumference of the first recess portion 39 on the outer surface 35 of the flange portion 30 but also to extend continuously in the circumferential direction along the full circumference of the flange portion 30 into an annular shape. Namely, this projecting portion 41 extends continuously in the circumferential direction along the full circumference of the flange portion 30 and is then formed into the annular shape and is further provided on an outer side of the first recess portion 39 concentrically therewith (refer to FIG. 3A). In this embodiment, the projecting portion 41 projects, as seen in section, to be protuberant in a direction in which the projecting portion 41 moves away from the front side of the hole 5 with an apex portion thereof rounded and is formed substantially into a ridge shape in section in which both side portions are lowered moderately (refer to FIG. 4). The projecting portion 41 may be an annular projection or the like in section including, for example, a semicircular sectional shape, an angular sectional shape and a trapezoidal sectional shape. However, it is preferable that the projecting portion 41 is formed into the shape of a projecting curved surface to avoid a concentration of stress.

Further, as shown in FIGS. 3A and 4, the second recess portion 43 is provided so as not only to be disposed at an outer circumference of the projecting portion 41 on the outer surface 35 of the flange portion 30 but also to extend continuously in the circumferential direction along the full circumference of the flange portion 30 into an annular shape and is further provided at the outer circumference of the projecting portion 41 concentrically therewith (refer to FIG. 3A). In this embodiment, the second recess portion 43 is depressed or inwardly curved into the shape of a curved surface of a predetermined depth from an outer surface 35 side of the flange portion 30 towards a direction in which it moves towards the front side of the hole 5 (refer to FIG. 4). As with the first recess portion, a sectional shape of the second recess portion may be any of, for example, a shape that is depressed or inwardly curved substantially into the shape of an arc, a shape that is depressed or inwardly curved substantially into the shape of a valley and a shape that is depressed or inwardly curved substantially into the shape of a trapezoid. However, it is preferable that the second recess portion takes a shape that is depressed or inwardly curved into the shape of a curved surface to avoid a concentration of stress.

Thus, as has been described heretofore, in this embodiment, the annular first recess portion 39, the annular projecting portion 41 and the annular second recess portion 43 are formed sequentially in that order from the proximal end 31 side towards the distal end 33 side (in other words, from a radially inner side to a radially outer side of the flange portion 30) in a concentric fashion on the outer surface 35 of the flange portion 30 of the plug 10.

This embodiment of the present disclosure should be such that at least one first recess portion 39 is provided in the form of the recess that extends continuously in the circumferential direction along the full circumference of the flange portion 30 on the outer surface 35 side thereof the flange portion and that the thin portion 40 is provided on the first recess portion 39. Hence, neither the projecting portion 41 nor the second recess portion 43 may be provided. Additionally, another projecting portion may be provided at an outer circumference of the second recess portion 43 and a further recess portion may be provided at an outer circumference of the projecting portion so provided on the outer surface 35 of the flange portion 30. Namely, recess portions and projecting portions may be provided alternately from the proximal end side towards the distal end side of the flange portion 30 on the outer surface thereof.

On the other hand, as shown in FIGS. 3B and 4, the third recess portion 45 is provided substantially in the form of a recess that extends continuously in the circumferential direction along the full circumference of the flange portion 30 on the inner surface 37 of the flange portion 30 in a position corresponding to the first recess portion 39. Namely, the third recess portion 45 is formed into the annular recess that is formed to extend continuously along the circumferential direction of the flange portion 30 and is further formed concentrically with the outer circumference of the outer wall portion 25 (refer to FIG. 3B). In this embodiment, the third recess portion 45 is formed into the shape of a curved surface that reduces the thickness of the flange portion 30 by as scooping away by a predetermined depth or height the flange portion 30 in such a manner as to be depressed or outwardly curved relative to the inner surface 37 of the flange portion 30 in a direction in which it moves away from the front side of the hole 5, that is, in an opposite direction to the direction in which the first recess portion 39 and the second recess portion 43 are depressed or inwardly curved (refer to FIG. 4). In this embodiment, the third recess portion 45 is depressed or curved outwardly in shape over a range including the projecting portion 41 and the second recess portion 43 as well as the first recess portion 39. As with the first recess portion and the second recess portion, the third recess portion may be formed into a recess portion that is depressed or outwardly curved substantially into the shape of an arc, a shape that is depressed or outwardly curved substantially into the shape of a valley or a shape that is depressed or outwardly curved substantially into the shape of a trapezoid.

As shown in FIGS. 3B and 4, the abutment portion 47 configured to be brought into abutment with the front circumferential edge of the hole 5 is provided so as not only to be disposed at an outer circumference of the third recess portion 45 on the inner surface 37 of the flange portion 30 but also to protrude into the shape of an arc in section while extending continuously along the full circumference of the flange portion 30. The abutment portion 47 takes the shape of an annular projection that is formed to extend continuously in the circumferential direction of the flange portion 30 and is provided at the outer circumference of the third recess portion 45 concentrically therewith (refer to FIG. 3B). Since the abutment portion 47 has the arc-shaped sectional shape, even though the thickness of the predetermined member 1 changes, the abutment portion 47 is designed to be brought into abutment with the front circumferential edge of the hole 5 formed in the predetermined member 1 in an ensured fashion (refer to FIGS. 5A, 5B).

In this embodiment, although one annular abutment portion 47 is provided, the abutment portion may be configured so that two annular thick portions are formed into a double ring configuration or a plurality of or three or more thick portions are formed into a multiple ring configuration, and hence, the configuration of the abutment portion is not limited to any specific configuration, provided that the abutment portion can be brought into abutment with the front circumferential edge of the hole 5. In addition, in this embodiment, although the abutment portion 47 is provided at the distal end 33 side of the flange portion 30, the abutment portion 47 may be provided, for example, in a radially halfway position on the inner surface 37 of the flange portion 30, provided that the abutment portion can be brought into abutment with the front circumferential edge of the hole. Even though this occurs, the thin portion provided on the first recess portion needs to be disposed further radially inwards of the flange portion than the position on the abutment portion that is located nearest to the outer wall portion.

The outer circumferences of the second recess portion 43 and the abutment portion 47 of the flange portion 30, that is, an outer surface 33a of the distal end 33 of the flange portion in its extending direction rises so as to generate a gap relative to a surface of the predetermined member 1 in which the hole 5 is provided with the flange portion 30 in abutment with the front side of the hole 5 (refer to FIGS. 5 and 6). Due to this, in removing the plug 10 from the hole 5, when the closing portion 21 is pushed in to cause the flange portion 30 to warp back (refer to FIG. 6), the distal end 33 of the flange portion 30 is allowed to rise easily so as to be easily gripped. In addition, an annular notched portion 31a is formed on the inner surface 37 at the proximal end 31 side of the flange portion 30 so as to extend continuously in the circumferential direction thereof, facilitating a deformation of the flange portion 30.

The plug 10 that has been described heretofore is formed integrally from an elastic resin material such as rubber, elastic elastomer and the like.

Next, a method of using the plug 10 configured as described heretofore and working effects of the plug 10 will be described below.

Namely, the one end 23a side of the inner wall portion 23 and the one end 25a side of the outer wall portion 25 of the main body portion 20 of the plug 10 are inserted and pushed into the hole 5 provided in the predetermined member 1 from the front side of the hole 5 by gripping on the distal end 33 side of the flange portion 30 that is the outer circumference thereof. Then, the outer wall portion 25 and the inner wall portion 23 are inserted into the hole 5 while being guided by the tapered surface 26, and the engaging portion 27 is pressed by an inner circumference of the hole 5, causing the outer wall portion 25 to flex into an inside of the hole via the groove portion 29. In addition, the abutment portion 47 of the flange portion 30 is brought into abutment with the front circumferential edge of the hole, and therefore, the flange portion 30 is pressed by the front circumferential edge of the hole 5, whereby the flange portion 30 flexes and deforms. When the plug 10 continues to be pushed in further, allowing the engaging portion 27 to move out of a rear side of the hole 5, the outer wall portion 25 elastically restores, and the engaging portion 27 comes into abutment with the rear circumferential edge of the hole 5, bringing the abutment portion 47 of the flange portion 30 into elastic abutment with the front circumferential edge of the hole 5, whereby the plug 10 can be mounted in the hole 5 with the hole 5 closed by the plug 10 as shown in FIG. 5A by holding the predetermined member 1 by the engaging portion 27 and the flange portion 30.

Incidentally, as has been described above, in mounting the plug 10 in the hole 5, the flange portion 30 is pressed against the front circumferential edge of the hole 5 to deform. As this occurs, with the plug constructed in the way described heretofore, since the flange portion 30 extends from the other end 25b side of the outer wall portion 25, in the case where the flange portion 30 flexes and deforms, a deformation tends to occur easily such as one in which the outer wall portion 25 falls into the inside of the hole 5.

With the plug 10 of this embodiment, however, as shown in FIG. 4, the first recess portion 39, which is formed into the recess extending continuously along the full circumference of the flange portion 30, is provided on the outer surface 35 of the flange portion 30, and the thin portion 40, whose minimum thickness T2 is thinner than the thickness T1 of the portion of the outer wall portion 25 that is located nearer to the outer end 25b side than the engaging portion 27, is formed on the first recess portion 39. The thin portion 40 is disposed further radially inwards of the flange portion 30 than the position on the abutment portion 47 that is located nearest to the outer wall portion 25.

Due to the configuration of the plug 10 described above, when the main body portion 20 is inserted into the hole 5 and the abutment portion 47 of the flange portion 30 is brought into abutment with the front circumferential edge of the hole 5 to mount the plug 10 in the hole 5, since the flange portion 30 deforms via the thin portion 40 that is provided further radially inwards of the flange portion 30 than the abutment portion 47, the flange portion 30 can be made to flex easily. As a result of this, the outer wall portion 25 of the plug 10 is prevented from deforming to fall into the inside of the hole 5 to thereby restrict an expansion of a gap defined between the outer circumference of the outer wall portion 25 and the inner circumference of the hole 5. This can enhance an adhesion of the outer wall portion 25 to the hole 5 to thereby improve the sealing performance of the plug 10 to the hole 5. In addition, as a result of the flange portion 30 being made to flex easily, the outer wall portion 25 is prevented from being affected by a flexure of the flange portion 30, and this makes it difficult for the outer wall portion 25 to be deformed into the inside of the hole 5, whereby the engaging portion 27 provided on the outer wall portion 25 is allowed to be brought into firm engagement with the rear circumferential edge of the hole 5, thereby making it possible to obtain a high engagement force relative to the hole 5.

FIG. 5B shows a case where the plug 10 is used to close a hole 5 provided in a predetermined member 1A whose thickness is thicker than the predetermined member 1 shown in FIG. 5A. In the case shown in FIG. 5B, since a thickness of the predetermined member 1A is increased, a pressing force exerted from a front side of the hole 5 becomes higher than that of the case shown in FIG. 5A, whereby the flange portion 30 is pressed more strongly and an amount of flexure and deformation of the flange portion 30 is increased. Even in this case, since the flange portion 30 flexes easily via the thin portion 40, the outer wall portion 25 is prevented from deforming, and this restricts the gap defined between the outer circumference of the outer wall portion 25 and the inner circumference of the hole 5 from expanding, whereby the adhesion of the outer wall portion 25 to the hole 5 can be enhanced, thereby making it possible to improve the sealing performance of the plug 10 relative to the hole 5.

Incidentally, there is a case where the plug 10 is wanted to be removed from the predetermined member 1 for replacement or maintenance of the plug 10 or classified recovery for reuse of the plug 10 when a vehicle is disposed as waste or for reuse. In this case, as indicated by an arrow in FIG. 5A, the closing portion 21 is pushed in towards the front side of the hole 5 with the plug 10 mounted in the hole 5. Then, as shown in FIG. 6, the distal end 33 of the flange portion 30 is pressed against the front side of the hole 5 via the abutment portion 47 on the inner side 37 thereof so that the flange portion 30 can be warped back via the first recess portion 39, whereby the distal end 33 of the flange portion 30 can be raised from the front side of the hole 5 so that the distal end 33 can be gripped on easily. As this occurs, since the first recess portion 39 is shaped to be depressed or curved inwardly in the direction in which it moves towards the front side of the hole 5, the flange portion 30 can be warped back more easily. Thereafter, the flange portion 30 is raised so as to move away from the front side of the hole 5 with the distal end 33 of the flange portion 30 kept gripped on to thereby release the engagement of the engaging portion 27 with the rear circumferential edge of the hole 5. This allows the outer wall portion 25 and the inner wall portion 23 to be pulled away from the front side of the hole 5, whereby the plug 10 can be removed from the hole 5. In this way, since the flange portion 30 can be warped back when the closing portion 20 is pushed in by designing the flange portion 30 to flex easily via the first recess portion 39, the distal end 33 can be pinched easily, thereby making it possible to improve the efficiency of removing work of removing the plug 10 from the hole 5.

Additionally, in this embodiment, as shown in FIG. 4, the projecting portion 41 is provided on the outer surface 35 of the flange portion 30 so as not only to be disposed at the outer circumference of the first recess portion 39 but also to be formed as the projection that extends continuously along the full circumference of the flange portion 30. Therefore, the rigidity required on the flange portion 30 can be ensured by increasing the thickness of the flange portion 30 by the amount by which the projecting portion 41 projects from the outer surface 35 of the flange portion 30, as a result of which the sealing performance of the plug 10 between the distal end 33 of the flange portion 30 and the front side of the hole 5 can be enhanced. Additionally, as shown in FIG. 6, when the closing portion 21 is pushed in to warp back the flange portion 30 to remove the plug 10 from the hole 5, an inner side of the projecting portion 41 (the radially inner side of the flange portion) and an outer side of the projecting portion 41 (the radially outer side of the flange portion) can be deformed easily via the projecting portion 41, and therefore, the distal end 33 of the flange portion 30 can easily be raided, thereby making it possible to improve the efficiency of removing work of removing the plug 10 from the hole 5.

Further, in this embodiment, as shown in FIG. 4, the second recess portion 43 is provided on the outer surface 35 of the flange portion 30 so as not only to be disposed at the outer circumference of the projecting portion 41 but also to be formed as the recess that extends continuously along the full circumference of the flange portion 30. Therefore, the outer circumferential portion of the flange portion 30 that is located radially outwards of the projecting portion 41 is deformed via the second recess portion 43 so that the distal end 33 side of the flange portion 30 can flex and deform easily, thereby making it possible to enhance the adhesion of the outer wall portion 25 to the hole 5 (refer to FIGS. 5A and 5B).

In addition, in this embodiment, as shown in FIG. 4, the third recess portion 45 is formed on the inner surface 37 of the flange portion 30 at the portion corresponding to the first recess portion 39 as the recess that extends continuously along the full circumference of the flange portion 30. Therefore, a portion that is thicker than the thin portion 40 can be provided on the flange portion 30 at portions located on an inner side of the thin portion 40 (the radially inner side of the flange portion) and an outer side of the thin portion 40 (the radially outer side of the flange portion) to thereby enhance the rigidity of the flange portion 30, whereby the sealing performance of the plug 10 between the distal end 33 of the flange portion 30 and the front side of the hole 5 can be enhanced while ensuring the adhesion of the outer wall portion 25 to the hole 5 (refer to FIGS. 5A and 5B). Further, as shown in FIGS. 5A and 5B, a greater distance can be ensured between the inner surface 37 side of the flange portion 30 and the front side of the hole 5, and therefore, when the plug 10 is removed from the hole 5, the closing portion 21 can be pushed in greatly, as a result of which the flange portion 30 can be warped back greatly, thereby making it possible to enhance the efficiency of removing work of removing the plug 10 from the hole 5.

Further, in this embodiment, as shown in FIG. 4, the abutment portion 47 is formed on the inner surface 37 of the flange portion 30 so as to be disposed at the outer circumference of the third recess portion 45 but also to be formed as a protuberant portion that protrudes into the shape of the arc in section while extending continuously along the full circumference of the flange portion 30. Therefore, as shown in FIGS. 5A and 5B, even though the thickness of the predetermined member 1 in which the hole 5 is provided changes, the abutment portion 47 having the arc-shaped section on the inner surface 37 of the flange portion 30 is in abutment with the front side of the hole 5 at all times, and therefore, the sealing performance of the flange portion 30 for the front side of the hole 5 can be obtained stably irrespective of change in thickness of the predetermined member 1 in which the hole 5 is provided.

It should be noted that the invention is not limited to the embodiment that has been described heretofore, and hence, various modified embodiments can be made to the invention without departing from the spirit and scope thereof, and the resulting embodiments so made are included in the scope of the invention.

What is claimed is:

1. A hole plug for closing a hole provided in a predetermined member, having a main body portion configured to be inserted into the hole and a seal flange portion configured to be brought into abutment with a front circumferential edge of the hole,
wherein the main body portion has a closing portion disposed on a front side of the hole, an inner wall portion extending from the closing portion to be inserted into the hole, an outer wall portion disposed on a radially outer side of the inner wall portion so as to be spaced apart therefrom and extending from one end side towards the other end side of the inner wall portion in its extending direction to be inserted into the hole and an engaging portion provided on an outer circumference of the outer wall portion to be brought into engagement with a rear circumferential edge of the hole,
wherein the seal flange portion extends outwards from the other end side of the outer wall portion and has an abutment portion configured to be brought into abutment with the front circumferential edge of the hole, and
wherein a first recess portion having a recess configuration extending continuously along a full circumference of the seal flange portion is provided on an outer surface of the seal flange portion, a thin portion whose minimum thickness is thinner than a thickness of a portion of the outer wall portion which is located closer to the other end side thereof than the engaging portion is formed on the first recess portion, and the thin portion is disposed closer to a radially inner side of the seal flange portion than a position on the abutment portion which is located nearest to the outer wall portion.

2. The hole plug according to claim 1, wherein a projecting portion disposed at an outer circumference of the first recess portion and formed into the shape of a projection extending continuously along a full circumference of the seal flange portion is provided on an outer surface of the seal flange portion.

3. The hole plug according to claim 2, wherein a second recess portion disposed at an outer circumference of the projecting portion and formed into the shape of a recess extending continuously along the full circumference of the seal flange portion is formed on the outer surface of the seal flange portion.

4. The hole plug according to claim 1, wherein a third recess portion formed into the shape of a recess extending continuously along the full circumference of the seal flange portion is provided on an inner surface of the flange portion at a portion corresponding to the first recess portion.

5. The hole plug according to claim 4, wherein the abutment portion of the seal flange portion is disposed at an outer circumference of the third recess portion and is shaped to protrude into an arc-like shape in section while extending continuously along the full circumference of the seal flange portion.
